(19) United States
(12) Patent Application Publication
(10) Pub. No.: US 2024/0308150 A1
(43) Pub. Date: Sep. 19, 2024

(54) Fixation of Fasteners to Wire Harness with Glue

(71) Applicant: Illinois Tool Works Inc., Glenview, IL (US)

(72) Inventors: Gerit Vollmer, Linden (DE); Jan Müller, Würzburg (DE); Jürgen Kohler, Königslutter am Elm (DE)

(21) Appl. No.: 18/605,563

(22) Filed: Mar. 14, 2024

(30) Foreign Application Priority Data
Mar. 17, 2023 (DE) 10 2023 106 791.5
Aug. 3, 2023 (DE) 10 2023 120 687.7
Mar. 7, 2024 (EP) 24162114.3

(51) Int. Cl. B29C 65/72; B29C 65/48; B60R 16/02

(52) U.S. Cl. CPC B29C 65/72; B29C 65/48; B60R 16/0215

(57) ABSTRACT

Disclosed is a fastening apparatus for fastening a first strand-like or elongated component having an approximately circular cross-section to a second component, in particular for fastening a cable or a cable harness to a carrier component or a vehicle body of a motor vehicle, is to be provided. This fastening apparatus includes a fastening body and a receiving body. The fastening body having a fastening means for connecting the fastening apparatus to a second component, in particular a carrier component or a vehicle body of a motor vehicle, and a receiving body, wherein the receiving body forms a receiving portion having a receiving surface facing in the direction of a first component for receiving a first component, and wherein an adhesive means is arranged on the receiving surface of the receiving portion in order to connect a first strand-like component, in particular a cable or a cable harness, to the receiving body directly by means of adhesion.

### RELATED APPLICATIONS

The present application claims the benefit of German Patent Application No. 10 2023 106 791.5, filed Mar. 17, 2023, German Patent Application No. 10 2023 120 687.7, filed Aug. 3, 2023, and European Patent Application No. 24162114.3, filed Mar. 7, 2024, each titled “Fixation of Fasteners to Wire Harness with Glue,” the contents of which are hereby incorporated by reference.

### BACKGROUND

Fastening apparatus for fastening a first component to a second component, as well as a method for assembling such a fastening apparatus

### SUMMARY

The present disclosure generally relates to a fastening apparatus for fastening a first strand-like component having an approximately circular cross-section to a second component, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a schematic, perspective view of a fastening apparatus according to the disclosure.

FIG. 2 illustrates a schematic, perspective view of the fastening apparatus according to the disclosure with a first component fastened thereto.

FIG. 3 illustrates a schematic, laterally cut view of the fastening apparatus of the disclosure with a first component having a larger diameter fastened thereto.

FIG. 4 illustrates a schematic, laterally cut view of the fastening apparatus according to the disclosure with a first component having a smaller diameter fastened thereto.

FIG. 5 illustrates a schematic, perspective view of a further development of the fastening apparatus according to the disclosure.

FIG. 6 illustrates a schematic side view of an assembly apparatus according to the disclosure for connecting a fastening apparatus according to the disclosure to a strand-like component in a home position.

FIG. 7 illustrates a schematic side view of the assembly apparatus according to the disclosure with a fastening apparatus.

FIG. 8 illustrates a schematic perspective view of a swage head of the assembly apparatus immediately prior to receiving the fastening apparatus according to the disclosure.

FIG. 9 illustrates a schematic perspective view of the swage head while receiving the fastening apparatus according to the disclosure.

FIG. 10 illustrates a schematic perspective view of the assembly apparatus with the fastening apparatus received.

FIG. 11 illustrates a schematic perspective view of the assembly apparatus with the fastening apparatus received, rotated by 60°, prior to receiving a strand-like component.

FIG. 12 illustrates a schematic perspective view of the assembly apparatus with the fastening apparatus received, while receiving a strand-like component.

FIG. 13 illustrates a further schematic perspective view of the assembly apparatus with the fastening apparatus received, rotated by a further 60°, before receiving a strand-like component.

FIG. 14 illustrates a schematic side view of the illustration from FIG. 13.

FIG. 15 illustrates a further schematic side view of a swage head of the assembly apparatus prior to connecting to a strand-like component.

FIG. 16 illustrates a schematic detail view of the swage head while connecting the fastening apparatus to the strand-like component.

FIG. 17 illustrates a schematic detail view of the swage head upon release from the fastening apparatus and the strand-like component connected thereto.

FIG. 18 illustrates a schematic side view of the strand-like component with the fastening apparatus connected thereto in a state having been released by the swage head.

### DETAILED DESCRIPTION

Disclosed is a fastening apparatus for fastening a first strand-like component having an approximately circular cross-section to a second component, in particular for fastening a cable or a cable harness to a carrier component of a vehicle body of a motor vehicle, as well as to a method for assembling such a fastening apparatus. A cable harness is an often ready-made bundling of individual leads that transmit signals (information) or work currents (energy). The leads are routed as a cable harness and wrapped or held together by clamps, cable ties, twine, or hoses. Such cable harnesses can be connected to a fastening apparatus by means of cable ties, wherein this fastening apparatus is then connected to a vehicle body in order to secure the harness. In addition, it can also be provided that a cable harness is connected to a fastening apparatus by means of tape, wherein the fastening apparatus is connected to a vehicle body in order to secure the cable harness.

One problem addressed by the present disclosure is to provide a fastening apparatus for fastening a first strand-like component having an approximately circular cross-section to a second component, in particular for fastening a cable or a cable harness to a carrier component or a vehicle body of a motor vehicle, as well as a method for its assembly, which are simple and safe and reliable in operation.

A further problem addressed by the present disclosure is to provide a fastening apparatus as well as a method for producing such a fastening apparatus that allow a first component to be easily and quickly assembled onto a second component.

In addition, problem addressed by the present disclosure is to form a fastening apparatus for fastening a first component to a second component, as well as a method for assembling such a fastening apparatus, which represents an alternative to known fastening apparatuses and methods.

According to the disclosure, a fastening apparatus for fastening a first strand-like or elongated component having an approximately circular cross-section to a second component, in particular for fastening a cable or a cable harness to a carrier component of a vehicle body of a motor vehicle, is to be provided. This fastening apparatus comprises: a fastening body having a fastening means for connecting the fastening apparatus to a second component, in particular a carrier component or a vehicle body of a motor vehicle, and a receiving body, wherein the receiving body forms a receiving portion having a receiving surface facing in the direction of a first component for receiving a first component, and wherein an adhesive means is arranged on the receiving surface of the receiving portion in order to connect a first strand-like component, in particular a cable or a cable harness, to the receiving body directly by means of adhesion.

In the context of the present disclosure, a strand-like or elongated component having an approximately circular cross-section is understood in particular to be a cable harness for a motor vehicle. However, the fastening apparatus can also be configured in order to fasten pipes or lines or the like. Thus, the elongated component can be one or more cables or wires arranged in hoses or wrapped with adhesive tape.

The fastening apparatus according to the disclosure is configured as a single part or as a single assembly, which can be provided immediately upon assembly of first components or cable harnesses in order to fasten them to a vehicle body.

In the context of the present disclosure, the fastening apparatus can nonetheless be formed from a plurality of components, which are however assembled in such a way or form a unit or assembly such that no further connecting means, in particular adhesive means, are necessary in order to fasten a first component to a second component. This means that the fastening apparatus according to the disclosure is free of additional fastening means, such as adhesive tape or cable ties, or does not comprise any further separate fastening means for connecting a first component, in particular a cable harness, to the fastening apparatus.

Accordingly, the fastening apparatus can be provided as a single component or as a single assembly, so that a first component can be immediately fastened to a second component without the need for further technical means. Therefore, no further adhesive or connecting means for connecting the first component or a cable harness to the fastening apparatus need be provided.

Furthermore, the present disclosure is wherein the fastening apparatus can be produced entirely as a single component or as an assembly, and in particular automatically.

Thus, the present disclosure is wherein a first component is immediately and directly connectable to the fastening apparatus in a single working step and does not first have to be first arranged on the fastening apparatus and then, in a second step, a fastening of this first component must be carried out on the fastening apparatus. In this way, the fastening apparatus according to the disclosure can be assembled in a simple, secure, and reliable manner.

The fastening apparatus additionally represents an alternative to fastening apparatuses known from the prior art.

The receiving portion can extend in a longitudinal direction corresponding to an axial direction of a first component to be received, and is formed in an approximately trench-shaped (or C-shaped) manner in cross-section.

By a predetermined extension in the longitudinal direction, a retaining force between the fastening apparatus and the first component is increased by means of a larger receiving surface.

The receiving portion can have a length of at least 2 cm or 4 cm or 5 cm or 6 cm or 7 cm, respectively. The receiving portion can have a length of maximum 8 cm or 10 cm or 12 cm or 15 cm, respectively.

Due to the approximately trench-shaped configuration of the receiving portion in cross-section, it is adaptable to an outer geometry of a first component to be received, or the receiving surface between the first component and the fastening apparatus is also increased, because a more laminar abutment of the receiving portion on a first component is possible.

The receiving portion can be a universal receiving portion for receiving strand-like components having different diameters, and wherein the universal receiving portion comprises a central, trench-shaped first receiving portion having a first radius and a trench-shaped second receiving portion having a second radius which is greater than the radius of the first receiving portion, wherein a trench-shaped sub-section of the second receiving portion is molded onto the two longitudinally extending edges of the first trench-shaped receiving portion, respectively, wherein these two sub-sections form the second receiving portion.

By providing a universal receiving portion having at least a first and a second receiving portion, only a single fastening apparatus is still necessary in order to arrange first components, in particular cable harnesses having different diameters, by means of a single fastening apparatus on a second component, in particular a carrier component or a body of a motor vehicle.

Due to the fact that a single fastening apparatus can be provided for cable harnesses of varying diameters, costs is reduced, because only a single type of fastening apparatus need be provided.

Furthermore, the universal receiving portion can also comprise three or four or more receiving portions by a corresponding segmentation or structuring of the receiving portion of the fastening apparatus with different radii and different receiving portions.

The fastening body and the receiving body can be integrally connected to one another or can form a single component.

Such a fastening apparatus is accordingly easy to produce.

Such a fastening apparatus is in particular also particularly simple in construction.

Alternatively, the fastening body and the receiving body can be releasably, in particular re-releasably, connected to one another by means of a connecting means and thus have a modular structure, i.e., form two separate components.

A two-piece structure as an assembly facilitates a quick exchange and allows for a more flexible disassembly during repairs or maintenance.

In addition, different fastening means can be provided on the fastening body and/or different receiving portions can be provided on the fastening body, which also allows for a high degree of flexibility in the use of the fastening apparatus according to the disclosure.

Latching means, clip connections, screw connections, or rivet connections can be provided as connecting means between the fastening body and the receiving body.

The receiving portion can be configured so as to be flexible in the longitudinal direction.

The receiving portion can additionally and/or alternatively comprise film hinges extending orthogonally to the longitudinal direction.

On its lateral edge regions, the receiving body can comprise recesses that additionally and/or alternatively extend orthogonally to the longitudinal direction.

In this way, the receiving portion is segmented and/or flexibly configured in the longitudinal direction in such a way that it can be adapted to a curvature in the axial direction of a first receiving component.

The larger connecting surface between the receiving portion and a first component to be fastened provides a larger surface area covered with adhesive means, so that first components, in particular a cable harness, can be retained with a higher retaining force.

In addition, the risk that a component to be fastened becomes detached from the receiving portion by a corresponding flexure, for example during the assembly of a cable harness or during operation of the vehicle, is avoided, so that no damage to the adhesive connection between the receiving portion and the first component can be caused by flexure or by corresponding radii.

The fastening body can be approximately centrally connected to the receiving body in such a way that the fastening apparatus is approximately T-shaped and in such a way that the receiving surface of the receiving body and a fastening surface of the fastening body face in opposite directions, i.e., diametrically opposed to one another.

The adhesive means can be for, for example, a pressure-sensitive adhesive (PSA), a double-sided adhesive tape, a UV adhesive, a superglue (cyanoacrylate), or a hot melt glue.

In this case, a retaining force of the adhesive connection of up to 250 N can be achieved. At higher forces, the adhesive connection does not yield, rather the tear strength of the adhesive tape is achieved.

The fastening means can be a latching device or a screwing means or an adhesive means.

Furthermore, according to the present disclosure, a method is provided for fastening a first strand-like or elongated component having an approximately circular cross-section to a second component, in particular for fastening a cable or a cable harness to a carrier component of a motor vehicle with a fastening apparatus as described above. This method comprises the following steps: adhering a first component to a receiving surface of a receiving portion of a receiving body of the fastening apparatus, and fastening a fastening body of the fastening apparatus to a second component, in particular using a corresponding fastening means.

The advantages of the method according to the disclosure correspond largely to the advantages described above of the fastening apparatus according to the disclosure.

In particular, an approximately cross-section is understood in particular to be a cross-section of a cable harness, wherein, in the case of a corresponding wrapping of two or more cables by means of an adhesive tape or a hose or a heat-shrunk tube, crimped or not exactly circular cross-sections can result, which are nevertheless referred to as “approximately circular” in the context of the present disclosure.

In addition, according to the present disclosure, a method for producing a fastening apparatus as described above is provided. This method comprises the following steps: producing a fastening body and a receiving body from a plastic by means of a 1-component injection molding process, and applying, in particular automatically applying, an adhesive means onto a receiving surface of a receiving portion of the receiving body.

The advantages of the method according to the disclosure for producing the fastening apparatus have already been described above on the basis of the fastening apparatus according to the disclosure. This method is nonetheless characterized in particular in that a fastening apparatus can be produced in advance or in one or more work steps as a single component or as a single assembly together with adhesive means for connecting the fastening apparatus to a first component, such that a separate adhesive means need not be used later in the assembly of a cable harness, where a first component must then first be arranged in a receiving portion and then subsequently connected to the receiving portion by means of a separate adhesive means.

In the following, further technical features of the fastening apparatus according to the disclosure are described in greater detail.

With the fastening apparatus according to the disclosure, a fastening apparatus for fastening strand-like first components to a second component, which can be fully automated, is provided for the first time, and for the final connection of the strand-like first component to the fastening apparatus, neither an adhesive tape nor a cable tie is required.

According to the disclosure, the strand-like component can be glued directly onto the receiving portion of the fastening apparatus.

The synergistic effect here also results in the fact that strand-like components having different diameters or different cable harness diameters no longer pose a problem, because the entire circumference of the strand-like component does not need to be wrapped. In particular, a hot melt adhesive is provided as the adhesive means.

Necessary contact pressure can be applied to a robotic device by a special application tool. Alternatively, a UV adhesive or a superglue could also be provided as the adhesive means. The advantage of hot melt adhesive, however, is that it allows for high temperature resistance, high hydrolysis resistance, rapid initial adhesion, resistance to vibration and chemicals, and high retaining forces.

For arranging a strand-like component on the receiving surface of the receiving body at least in a pre-assembly position before the strand-like component is connected to the receiving surface, in particular completely, via the adhesive means, the fastening apparatus can be provided with at least one or two, or also a plurality of, pre-assembly retaining bands extending orthogonally to the longitudinal direction, wherein the retaining bands are free of detent means.

The pre-assembly retaining bands are made in particular from a particularly inexpensive material, for example a film, because they are only intended to fix the strand-like component in the receiving portion in a pre-assembly position until the adhesive agent is sufficiently cured in order to ensure a complete connection between the strand-like component and the receiving surface. The pre-assembly retaining bands themselves preferably do not comprise any detent means and also no glue or other bonding means.

Often, when assembling cable harnesses, it is required that they be connected by winding the strand-like component in a fully circumferential manner together with the fastening apparatus. In addition, an extremely short cycle time is usually provided during assembly.

In order to meet these requirements, according to the disclosure, a pre-assembly of the strand-like component on the holder portion by means of corresponding pre-assembly retaining bands is provided.

These can be wound, in particular in an automated or automatic fashion, around the positioned strand-like component and the receiving portion of the fastening apparatus by means of a robotic device.

The pre-assembly retaining belt is preferably a film formed from a very thin and inexpensive material. The pre-assembly retaining band(s) serve only to arrange the strand-like component to be fastened in a pre-assembly position on the receiving portion until the adhesive means is sufficiently cured in order to allow a safe and reliable connection between the first strand-like component and the receiving portion.

Advantageously, the pre-assembly retaining bands can act as a barrier, depending on the design, shape, and size, in order to prevent excess adhesive from being smeared.

In addition, a correct arrangement and positioning of the adhesive means between the strand-like component and the receiving portion can be enabled by means of the pre-assembly retaining bands.

The provision of the pre-assembly retaining bands thus has the advantage that a very short cycle time can be realized with the fastening apparatus according to the disclosure, as no waiting time is necessary until the glue is at least half dried or totally cured.

The fastening apparatus according to the disclosure with retaining bands can comprise all technical features of the fastening apparatus described above.

Furthermore, according to the present disclosure, a method is provided, in particular a pre-assembly method for connecting a strand-like component, in particular a cable or a cable harness, to a fastening apparatus. This method comprises the following steps: receiving the fastening apparatus by means of an assembly apparatus, connecting the fastening apparatus to the strand-like component by one or two retaining bands by winding the strand-like component and a receiving body of the fastening apparatus together, and forming an adhesive connection between the strand-like component and the receiving body of the fastening apparatus.

Furthermore, the retaining bands can also be removed when the adhesive means has cured sufficiently in order to hold the strand-like first component on the receiving surface of the receiving portion.

In addition, according to the present disclosure, the method of production of the fastening apparatus according to the present disclosure can comprise the following steps: optionally conveying a fastening apparatus to a processing apparatus, in particular a rotary table; cleaning, in particular plasma-cleaning, at least one receiving surface of the receiving body of the fastening apparatus; and applying adhesive means to a receiving surface of the receiving surface of the receiving body.

Furthermore, the method, in particular the pre-assembly method for connecting a strand-like component, in particular a cable or a cable harness, to a fastening apparatus, can comprise in detail the following steps: receiving the fastening apparatus by means of the assembly apparatus.

In particular, removing the fastening apparatus from the processing apparatus by means of the assembly apparatus, which comprises a guide device configured so as to be approximately C-shaped and a swage head connected thereto.

The guide device can be movably configured and the swage head can be fixedly configured. Alternatively, the guide device can be fixedly configured and the swage head can be movably configured. The assembly apparatus can be configured as a robot.

To remove a fastening apparatus from the processing apparatus by means of the assembly apparatus configured as a robot, the swage head can be moved to a removal position in the region of the processing apparatus in order to remove the fastening apparatus from the processing apparatus.

In this case, it can be provided that the swage head comprises a suction cup. The swage head then travels into the region of the processing apparatus and receives the fastening apparatus.

The reception can be carried out in particular by means of respective suction cups of the swage head, which suction onto correspondingly configured, preferably plate-shaped, suction surfaces of the processing apparatus in order to receive the fastening apparatus by means of the swage head.

The processing apparatus can comprise a retaining apparatus, in particular a gripper, for fixing the fastening apparatus during processing, in particular during cleaning and application of adhesive means.

This retaining means (or gripper) is opened or releases the fastening apparatus so that it can be removed from the fastening apparatus by the assembly apparatus.

Optionally, the gripper can extend out of the processing apparatus, for example downwardly, in such a way that the assembly apparatus can remove the processing apparatus. Then, the swage head can be rotated by 180°.

The robot then travels with the swage head out of the processing apparatus or rotary table.

The robot can now be positioned such that a strand-like component can be arranged in or threaded into a receiving space of the C-shaped-shaped guide device and thus takes a threading position.

The swage head of the robot is then positioned either by movement of the swage head and/or by movement of the guide device in such a way that a strand-like component is arranged in the region of a retaining element of the swage head.

The swage head then rotates in a servo-controlled manner by a predetermined angular range along the guide device, for example up to 180° or up to 60°, such that the retaining element is arranged in a vertical direction below the strand-like component and the swage head is arranged in a vertical direction above the strand-like component.

The retaining element then travels until it contacts the strand-like component.

Subsequently, the suction device moves the fastening apparatus to the strand-like component so that it is pressed against the retaining element.

The strand-like component can now be connected to the receiving body of the fastening apparatus by winding them together by means of the fastening apparatus via one or two retaining bands.

The adhesive connection between the strand-like component and the receiving body of the fastening apparatus can then be formed.

Then, the swage head can be released from the fastening apparatus.

The robot can subsequently remove the swage head from the strand-like component and the fastening apparatus connected thereto.

The strand-like component can then be connected to a carrier component via the fastening apparatus connected thereto.

Optionally, the retaining bands can be removed after the adhesive joint has cured.

The method described above for fastening a first strand-like component having an approximately circular cross-section to a second component, in particular for fastening a cable or a cable harness to a carrier component of a motor vehicle, comprises the following additional steps according to one further development: pre-assembling the strand-like component by means of one or two retaining bands by winding, in particular by means of a robotic device, the strand-like component and the receiving body together; feeding the adhesive means to the receiving surface via an adhesive supply channel that opens into the receiving surface, and when the adhesive means is sufficiently cured in order to retain the strand-like first component on the receiving surface of the first receiving portion, removing the retaining bands.

Furthermore, a method is provided, in particular a final assembly method, for fastening a fastening apparatus which has a first strand-like component, in particular a cable or a cable harness, connected thereto, to a carrier component of a motor vehicle, having a fastening apparatus, comprising the following steps: fastening a fastening body of the fastening apparatus to a second component.

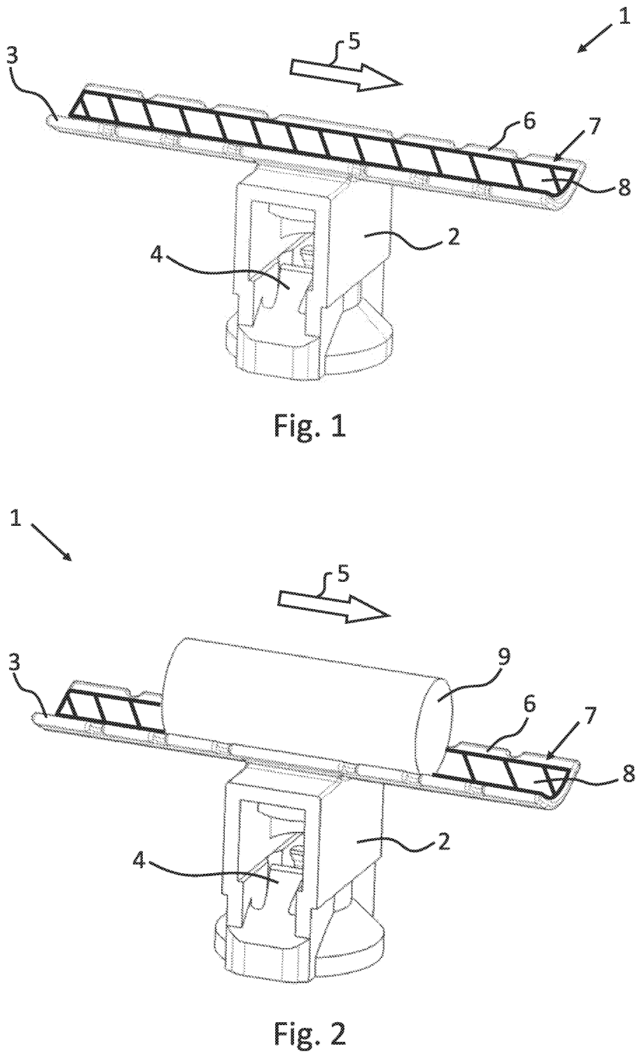

A fastening apparatus 1 for fastening a first strand-like or elongated component 9 having an approximately circular cross-section to a second component, in particular for fastening a cable or a cable harness to a carrier component or a vehicle body of a motor vehicle, comprises a fastening body 2 and a receiving body 3 (FIGS. 1 through 5).

The fastening apparatus 1 can be approximately T-shaped. However, the fastening apparatus 1 can also have another suitable shape, such as the shape described by way of example using the only exemplary embodiment.

The fastening body 2 comprises a fastening means 4 at its free end. In the present exemplary embodiment, the fastening means 4 is a bolt fastener (stud retainer).

However, the fastening means 4 can also be configured as another fastening means, which is not configured for fastening the fastening apparatus 1 to a bolt of a carrier component, for example a corresponding latching device, a screw connection, a rivet connection, or another suitable connection.

Preferably, the following fastening means are provided: blind-hole fastening with metal clip; fastening on an edge with an edge clip; clip solution into a hole (e.g., with pinetree foot); fastening to bolts with a bolt receptacle (see figures); and a corresponding retaining force is approximately 150 N.

According to this exemplary embodiment, the receiving body 3 is integrally connected to the fastening body 2, so that they are formed as a single component. The fastening body 2 and the receiving body 3 can in particular be made from a plastic by means of a 1-component injection molding process.

According to an alternative embodiment (not shown), the fastening body 2 and the receiving body 3 are configured as two separate or individual components, which can be connected to one another by means of a corresponding connecting means.

A locking means or a clip connection or a screw connection or the like can preferably be provided as the connecting means.

The fastening body 2 comprises an elongated receiving portion 6 extending in a longitudinal direction 5.

The longitudinal direction 5 corresponds to an axial direction of a first strand-like or elongated component 9 or a cable harness that is to be received.

In the present exemplary embodiment, the receiving portion 6 is approximately trench-shaped and/or C-shaped in cross-section orthogonally to the longitudinal direction 5.

A surface of the receiving portion 6 facing away from the free end of the fastening body 2 and the fastening means 4, respectively, is referred to as the receiving surface 7. The receiving surface 7 thus faces in the direction of a first component or cable harness to be received.

On the receiving surface 7, an adhesive means 8 is preferably applied in a full-surface or nearly full-surface manner.

In the context of the present disclosure, the terms “full-surface” and “nearly full-surface” are understood to mean that approximately 70% or approximately 80% or approximately 90% or approximately 95% or approximately 100% of the receiving surface 7 is covered with an adhesive means 8, i.e., the adhesive means 8 is arranged in such a way on the receiving surface.

The fastening body 2 and the receiving body 3 can be formed from a plastic, such as PA66, PA6, or POM. Preferably, PA66 is provided.

The adhesive means 8 can be for, for example, a pressure-sensitive adhesive (PSA), a double-sided adhesive tape, a UV adhesive, a superglue (cyanoacrylate), or a hot melt glue.

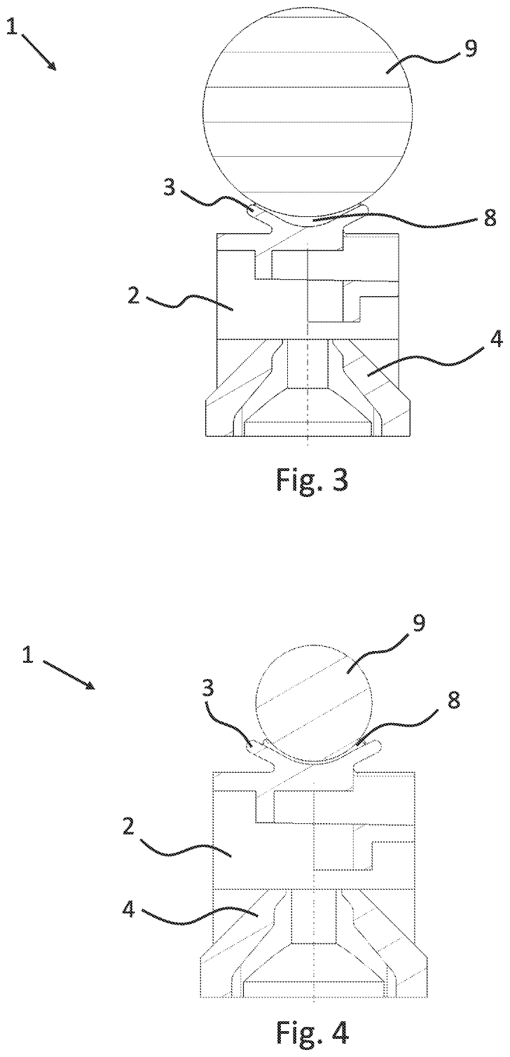

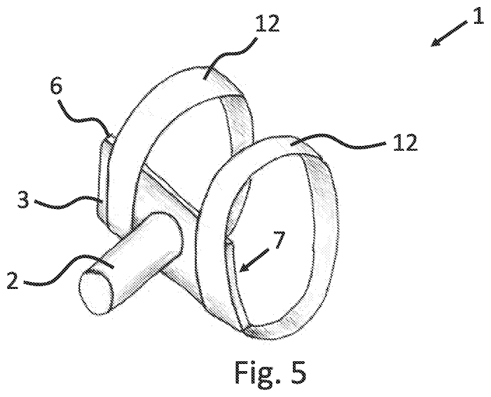

The receiving portion 6 can be configured so as to receive strand-like first components 9 having different diameters (FIGS. 3 and 4).

To arrange a strand-like component on the receiving surface 7 of the receiving portion 6 of the receiving body 3 in a pre-assembly position, two additional pre-assembly retaining bands 12 extending orthogonally to the longitudinal direction 5 can be provided (FIG. 5).

The pre-assembly retaining bands 12 are made from an inexpensive, cost-effective material free of detent agents or adhesives, in particular from a simple film that circumferentially completely surrounds or repeatedly wraps the strand-like first component 9 and portions of the receiving body 3 facing away from the strand-like first component, so that the strand-like first component 9 is connected to the receiving body 3 in a pre-assembly position.

According to a further development of the fastening apparatus according to the disclosure (not shown), the receiving portion 6 can be a universal receiving portion for receiving strand-like first components 9 having different diameters (not shown).

It is then provided that the universal receiving portion comprises a central, trench-shaped first receiving portion 6 having a first radius. On lateral edges of this first receiving portion 6, which extend in the longitudinal direction 5, two sub-sections, which are also approximately trench-shaped, are respectively molded, forming the second receiving portion 6.

It could also be provided here that, in the same way as the second receiving section 6 connects to the first receiving section 6, further third or fourth receiving sections are also provided.

The two sub-sections then form the second receiving portion 6 which has a larger radius than the first receiving portion 6.

In particular, the receiving portion 6 is configured so as to be flexible in the longitudinal direction 5.

According to the present exemplary embodiment, the free edges of the receiving portion 6 extending in the longitudinal direction 5 comprise recesses or notches extending orthogonally to the longitudinal direction 5, which segment the receiving portion 6 such that it is configured so as to be flexible in the longitudinal direction 5.

Additionally and/or alternatively, film hinges extending orthogonally to the longitudinal direction 5 can also be provided in the receiving section 6.

Furthermore, according to the present disclosure, a method is provided for fastening a first strand-like or elongated component 9 having an approximately circular cross-section to a second component, in particular for fastening a cable or a cable harness to a carrier component of a motor vehicle with a fastening apparatus 1 as described above. This method comprises the following steps: adhering a first component 9 to a receiving surface 7 of a receiving portion 6 of a receiving body 3 of the fastening apparatus 1; and fastening a fastening body 2 of the fastening apparatus 1 to a second component, in particular using a corresponding fastening means.

In particular, according to the present disclosure, a method for producing a fastening apparatus 1 as described above is provided. This method comprises the following steps: producing a fastening body 2 and a receiving body 3 from a plastic by means of a 1-component injection molding process; and applying, in particular automatically applying, an adhesive means 8 onto a receiving surface 7 of a receiving portion 6 of the receiving body 3.

Furthermore, according to the present disclosure, a method is provided, in particular a pre-assembly method for connecting a strand-like component, in particular a cable or a cable harness, to a fastening apparatus. This method comprises the following steps: receiving the fastening apparatus by means of an assembly apparatus 10; connecting the fastening apparatus to the strand-like component by one or two retaining bands by winding the strand-like component and a receiving body of the fastening apparatus together; and forming an adhesive connection between the strand-like component and the receiving body of the fastening apparatus.

Furthermore, the retaining bands can also be removed when the adhesive means has cured sufficiently in order to hold the strand-like first component on the receiving surface of the receiving portion.

In addition, according to the present disclosure, the method of production of the fastening apparatus according to the present disclosure can comprise the following steps: optionally conveying a fastening apparatus to a processing apparatus, in particular a rotary table; cleaning, in particular plasma-cleaning, at least one receiving surface of the receiving body of the fastening apparatus; and applying adhesive means to a receiving surface of the receiving surface of the receiving body.

Furthermore, the method, in particular the pre-assembly method for connecting a strand-like component, in particular a cable or a cable harness, to a fastening apparatus, comprises in detail the following steps: receiving the fastening apparatus by means of the assembly apparatus 10.

In particular, removing the fastening apparatus from the processing apparatus (not shown) by means of the assembly apparatus 10, which comprises a guide device 11 configured so as to be approximately C-shaped and a swage head connected thereto.

The guide device 11 can be movably configured and the swage head can be fixedly configured. Alternatively, the guide device 11 can be fixedly configured and the swage head can be movably configured.

The assembly apparatus 10 can be configured as a robot.

To remove a fastening apparatus from the processing apparatus by means of the assembly apparatus 10 configured as a robot, the swage head is moved to a removal position in the region of the processing apparatus in order to remove the fastening apparatus from the processing apparatus.

It is provided in this case that the swage head comprises a suction cup 14 or other suitable receiving means. The swage head then travels into the region of the processing apparatus and receives the fastening apparatus.

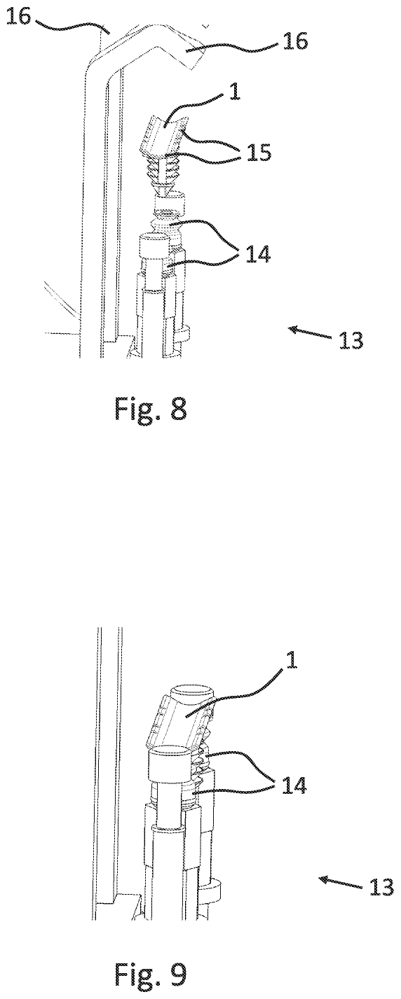

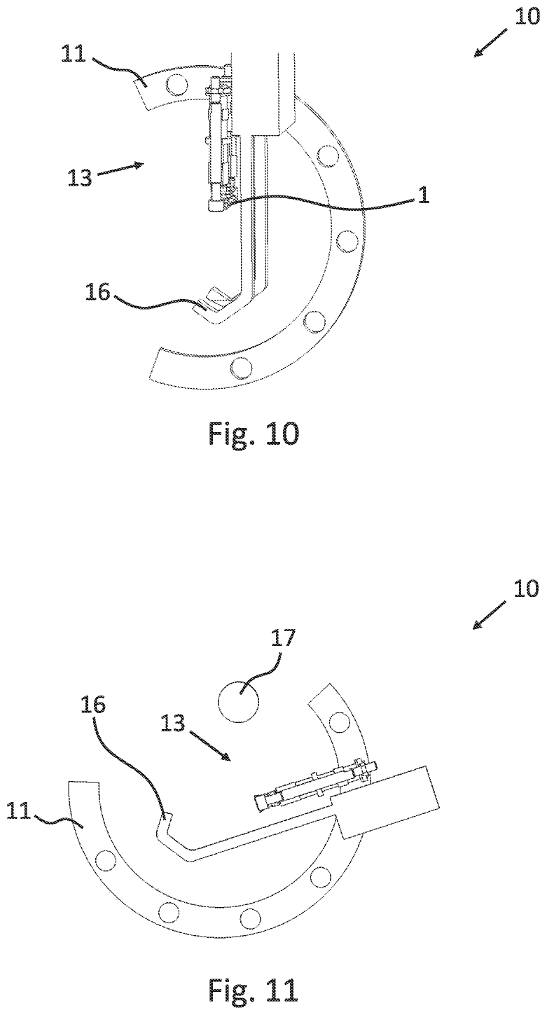

The reception is carried out in particular by means of respective suction cups of the swage head 13, which suction onto correspondingly configured, preferably plate-shaped, suction surfaces 15 of the processing apparatus in order to receive the fastening apparatus by means of the swage head 13 (FIGS. 8 and 9).

The processing apparatus comprises a retaining apparatus, in particular a gripper (not shown), for fixing the fastening apparatus during processing, in particular during cleaning and application of adhesive means.

This retaining means (or gripper) is opened or releases the fastening apparatus so that it can be removed from the fastening apparatus by the assembly apparatus 10.

Optionally, the gripper can extend out of the processing apparatus, for example downwardly, in such a way that the assembly apparatus 10 can remove the processing apparatus.

Then, the swage head 13 is rotated by 180°.

The robot then travels with the swage head 13 out of the processing apparatus or rotary table (not shown).

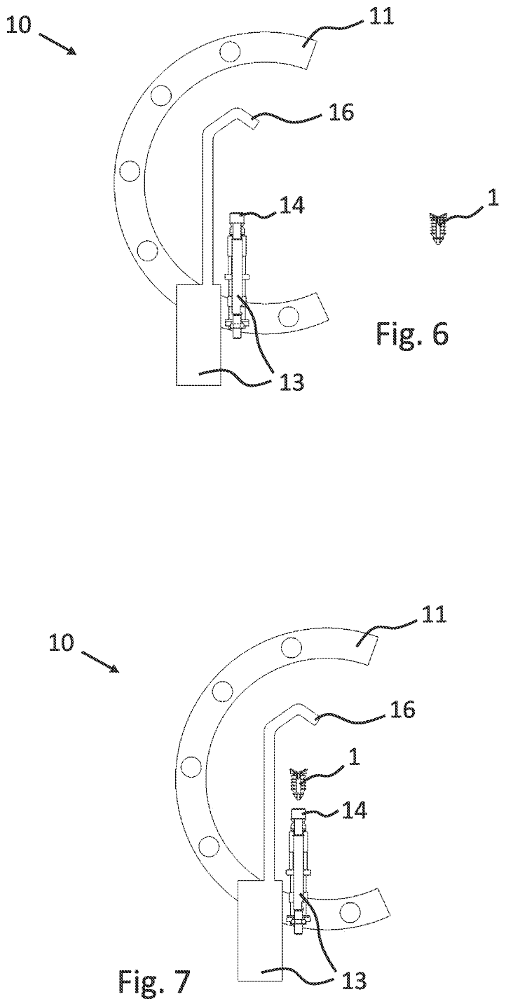

The assembly apparatus 10 or robot is now positioned such that a strand-like component 17 can be arranged in or threaded into a receiving space of the C-shaped-shaped guide device 11 and thus takes a threading position (FIG. 6).

The swage head of the robot is then positioned either by movement of the swage head 13 and/or by movement of the guide device 11 in such a way that a strand-like component 17 is arranged in the region of a retaining element of the swage head (FIGS. 7, 8, and 9).

The swage head 13 then rotates in a servo-controlled manner by a predetermined angular range along the guide device 11, for example up to 180° or up to 60°, such that the retaining element 16 is arranged in a vertical direction below the strand-like component 17 and the swage head 13 is arranged in a vertical direction above the strand-like component 17.

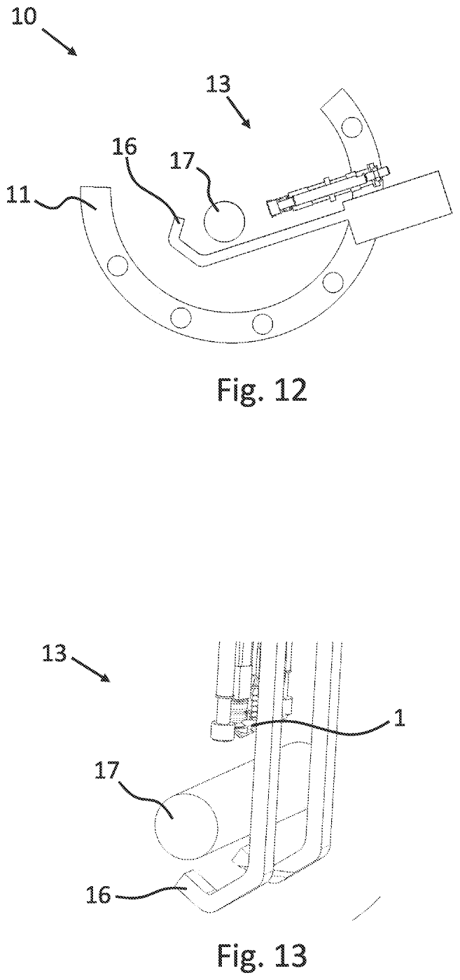

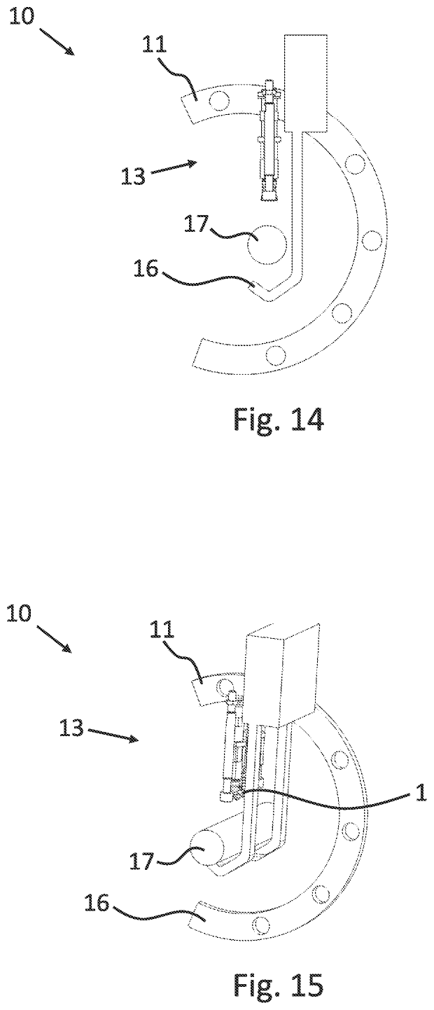

The retaining element 16 then travels until it contacts the strand-like component (FIGS. 11 to 16).

Subsequently, the suction device moves the fastening apparatus to the strand-like component 17 so that it is pressed against the retaining element 16.

The strand-like component 17 can now be connected to the receiving body 3 of the fastening apparatus 1 by winding them together by means of the fastening apparatus via one or two retaining bands.

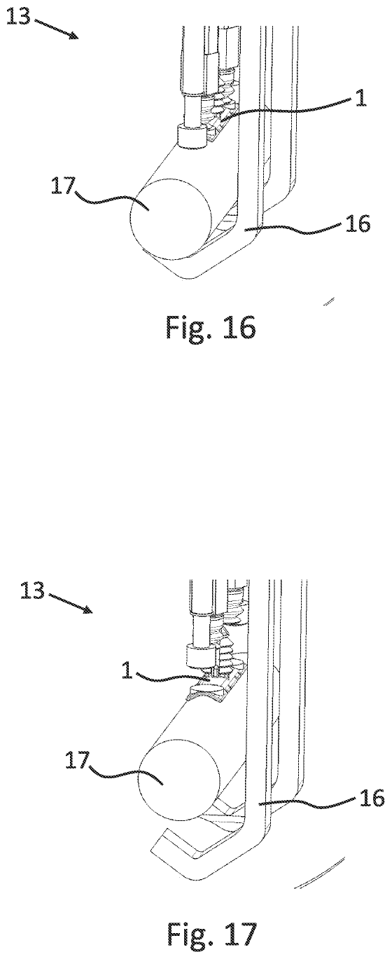

The adhesive connection between the strand-like component 17 and the receiving body 3 of the fastening apparatus 1 can then be formed (FIGS. 16 and 17).

Then, the swage head 13 is released from the fastening apparatus.

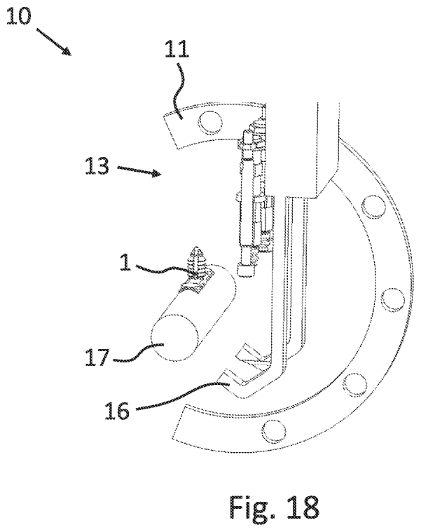

The robot subsequently removes the swage head 13 from the strand-like component and the fastening apparatus (FIG. 18) connected thereto.

The strand-like component 17 is then connected to a carrier component or second component (not shown) via the fastening apparatus 1 connected thereto.

Optionally, the retaining bands can be removed after the adhesive joint has cured.

The method described above for fastening a first strand-like component having an approximately circular cross-section to a second component, in particular for fastening a cable or a cable harness to a carrier component of a motor vehicle, comprises the following additional steps according to one further development: pre-assembling the strand-like component by means of one or two retaining bands by winding, in particular by means of a robotic device, the strand-like component and the receiving body together; feeding the adhesive means to the receiving surface via an adhesive supply channel that opens into the receiving surface; and when the adhesive means is sufficiently cured in order to retain the strand-like first component on the receiving surface of the first receiving portion, removing the retaining bands.

Furthermore, a method is provided, in particular a final assembly method, for fastening a fastening apparatus which has a first strand-like component, in particular a cable or a cable harness, connected thereto, to a carrier component of a motor vehicle, having a fastening apparatus, comprising the following steps: fastening a fastening body of the fastening apparatus to a second component.

List of reference numerals

| | |
|---|---|
| 1 | Fastening apparatus |
| 2 | Fastening body |
| 3 | Receiving body |
| 4 | Fastening means |
| 5 | Longitudinal direction |
| 6 | Receiving portion |
| 7 | Receiving surface |
| 8 | Adhesive means |
| 9 | First component |
| 10 | Assembly apparatus |
| 11 | Guide device |
| 12 | Pre-assembly retaining bands |
| 13 | Swage head |
| 14 | Suction cup |
| 15 | Suction surfaces |
| 16 | Retaining element |
| 17 | Strand-like component |

What is claimed is:

1. A fastening apparatus (1) for fastening a first strand-like component (9) having an approximately circular cross-section to a second component, in particular for fastening a cable or a cable harness to a carrier component of a motor vehicle, comprising
a fastening body (2) having a fastening means (4) for connecting the fastening apparatus (1) to a second component, in particular a carrier component of a motor vehicle, and
a receiving body (3), wherein the receiving body (3) forms a receiving portion (6) having a receiving surface (7) facing in a direction of a first component for receiving a first component, and wherein an adhesive means (8) is or can be arranged on the receiving surface (7) of the receiving portion (6) in order to connect a first strand-like component (17), in particular a cable or a cable harness, to the receiving body (3) by means of adhesion.

2. The fastening apparatus (1) according to claim 1, wherein the receiving portion (6) extends in a longitudinal direction (5) corresponding to an axial direction of a first component to be received and is formed in an approximately trench-shaped (or C-shaped) manner in cross-section.

3. The fastening apparatus (1) according to claim 2, wherein at least one or two pre-assembly retaining bands (12) extending orthogonally to the longitudinal direction for arranging a strand-like component on the receiving surface of the receiving body (3) at least in a pre-assembly position before the strand-like component (9) is connected to the receiving surface (7) via the adhesive means (8).

4. The fastening apparatus (1) according to claim 1, wherein the receiving portion (6) extends in a longitudinal direction (5) corresponding to an axial direction of a first component to be received and is formed in an approximately trench-shaped manner in cross-section.

5. The fastening apparatus (1) according to claim 1, wherein the fastening body (2) and the receiving body (3) are integrally connected to one another, or that the fastening body (2) and the receiving body (3) are releasably, in particular re-releasably, connected to one another by means of a connecting means and thus have a modular structure.

6. The fastening apparatus (1) according to claim 2,
wherein the receiving portion (6) is configured so as to be flexible in the longitudinal direction (5),
wherein the receiving portion (6) comprises film hinges extending orthogonally to the longitudinal direction (5), or
wherein the receiving portion (6) has recesses on its lateral edge regions extending orthogonally to the longitudinal direction (5),
so that the receiving portion (6) is segmented or flexibly configured in the longitudinal direction (5) in such a way that it can be adapted to a curvature in the axial direction of a first receiving component (9).

7. The fastening apparatus (1) according to claim 1, wherein the adhesive means (8) is a pressure-sensitive adhesive (PSA), a double-sided adhesive tape, a UV adhesive, a superglue (cyanoacrylate), or a hot melt glue.

8. A method for connecting a strand-like component, in particular a cable or a cable harness, to a fastening apparatus, comprising the following steps:
receiving the fastening apparatus by means of an assembly apparatus (10);
connecting the fastening apparatus to the strand-like component by one or two retaining bands by winding the strand-like component and a receiving body of the fastening apparatus (1) together; and
forming an adhesive connection between the strand-like component (17) and the receiving body (3) of the fastening apparatus.

9. The method of claim 8 for fastening a fastening apparatus (1) according to claim 1, which has a first strand-like component (9), in particular a cable or a cable harness, connected thereto, to a carrier component of a motor vehicle, comprising the following steps: fastening a fastening body (2) of the fastening apparatus (1) to a second component.

10. A method for producing a fastening apparatus (1) according to claim 1, comprising the following steps:
producing a fastening body (2) and a receiving body (3) from a plastic by means of a 1-component injection molding process; and
applying, in particular automatically applying, an adhesive means (8) onto a receiving surface (7) of a receiving portion (6) of the receiving body (3).
